(19) United States
(12) Patent Application Publication
(10) Pub. No.: US 2026/0331009 A1
(43) Pub. Date: Oct. 22, 2026

(54) IMAGE FORMING APPARATUS

(71) Applicant: SHARP KABUSHIKI KAISHA, Osaka (JP)

(72) Inventors: SOHICHI YOSHIMURA, Osaka (JP); Takashi MATSUDA, Osaka (JP); ATSUSHI KASENO, Osaka (JP); Tadashi SAITOH, Osaka (JP)

(21) Appl. No.: 19/560,435

(22) Filed: Mar. 9, 2026

(30) Foreign Application Priority Data
Mar. 18, 2025 (JP) 2025-043867

(51) Int. Cl. G09F 23/06; G03G 15/00; G03G 21/16; G09F 7/18; G09F 11/08; H04N 1/00

(52) U.S. Cl. CPC G09F 23/06; G03G 15/5016; G03G 21/1619; G03G 21/1633; G09F 7/18; G09F 11/08; H04N 1/00408; H04N 1/00496; H04N 1/00559; G09F 2007/1856; H04N 2201/0094

(57) ABSTRACT

There is provided a cover member that covers a main body of an image forming apparatus from an outside, wherein a surface of the cover member is a display surface that displays an image. Thus, it is possible to provide an image forming apparatus capable of displaying an image on the outer surface of the image forming apparatus without being subjected to time restriction, work restriction, and image restriction.

### BACKGROUND OF THE INVENTION

### Field of the Invention

The present disclosure relates to an image forming apparatus. This application is based on Japanese Patent Application No. 2025-043867 filed on Mar. 18, 2025, the contents of which are incorporated herein by reference.

### Description of the Background Art

In general, there has been proposed a multifunction peripheral (an example of an image forming apparatus such as a multi-printer) installed in a public space where people go in and out that displays functions on a display screen of a display device and displays various advertisement images.

In view of such circumstances, it is an object of the present disclosure to provide an image forming apparatus capable of displaying an image on an outer surface of the image forming apparatus without being subjected to time restriction, work restriction, and image restriction.

### SUMMARY OF THE INVENTION

The present disclosure is an image forming apparatus comprising a cover member that covers a main body of an image forming apparatus from an outside, wherein a surface of the cover member is a display surface that displays an image.

According to the image forming apparatus of the present disclosure, it is possible to achieve an excellent effect that an image can be displayed on the outer surface of the image forming apparatus without being subjected to time restriction, work restriction, and image restriction.

### BRIEF DESCRIPTION OF THE DRAWINGS

FIG. 1 is an explanatory perspective view of an image forming apparatus according to a first embodiment.

FIG. 2 is a front view of the image forming apparatus of FIG. 1.

FIG. 3 is a side view of the image forming apparatus of FIG. 1.

FIG. 4 is an explanatory view of attachment of a flat panel to the image forming apparatus of FIG. 1.

FIG. 5 is a block diagram of control of the image forming apparatus according to the first embodiment.

FIG. 6 is an explanatory view of an image forming apparatus according to a modification example 2.

FIG. 7 is an explanatory perspective view of an image forming apparatus according to a second embodiment.

### DESCRIPTION OF THE PREFERRED EMBODIMENTS

In general, there has been proposed a multifunction peripheral (an example of an image forming apparatus such as a multi-printer) installed in a public space where people go in and out that displays functions on a display screen of a display device and displays various advertisement images. On the other hand, in a store, there has been a demand for displaying an advertisement medium on an outer surface of a multifunction peripheral, which is installed in a public space of the store or the like and is visible to people, to represent the advertisement and use the advertisement for publicity.

In response to such a demand, in general, an advertisement is displayed on a multifunction peripheral by wrapping a sheet (medium) on which an image of the advertisement is displayed on an outer surface, particularly, a front surface of the multifunction peripheral.

For example, in the conventional multifunctional peripheral, when an advertisement medium such as a sheet is attached to the front surface of the image forming apparatus by a wrapping operation, there is time restriction that the wrapping operation is carried out by a specialized company at nighttime.

At this time, since the front surface of the image forming apparatus has irregularities in a portion on which the sheet is attached due to a boundary of the sheet feeding cassette, a handle, or the like, there is work restriction that a special work is required in which a dryer is used so that the advertisement medium that has been attached to the front surface follows the irregularities and a cutter is used to cut the advertisement medium so that the sheet feeding cassette can be opened.

In addition to the time restriction and the work restriction, there is also image restriction that the layout of the sheet feeding cassette needs to be considered for the wrapping image. Therefore, the wrapping is performed only in a limited store.

An image forming apparatus capable of solving one or more of such problems will be described below with reference to the drawings.

Note that the following embodiment is an example for describing the present disclosure, and the technical scope of the disclosure described in the claims is not limited to the following description.

### 1 First Embodiment

### 1.1 Configuration of Image Forming Apparatus

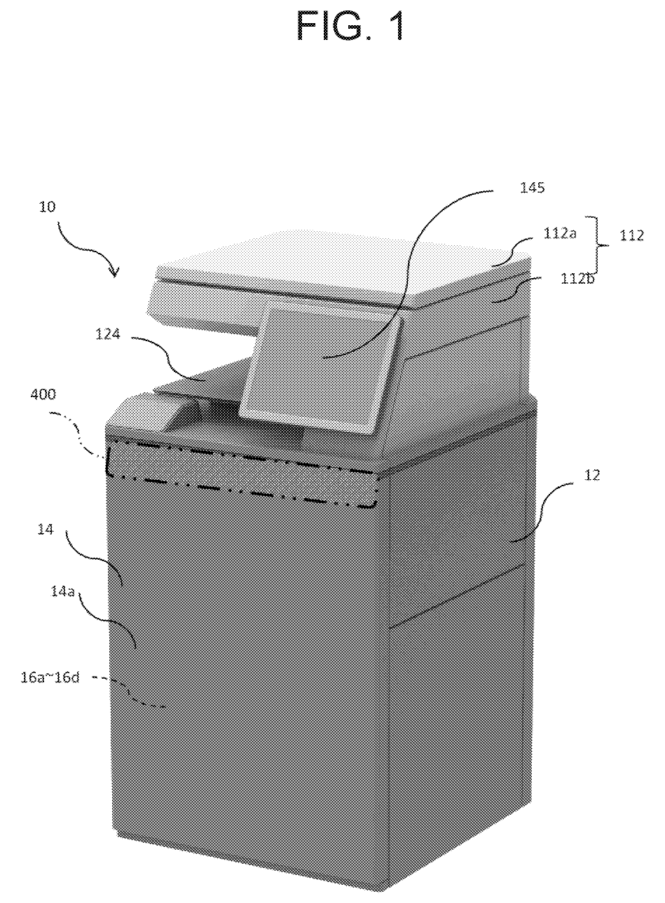

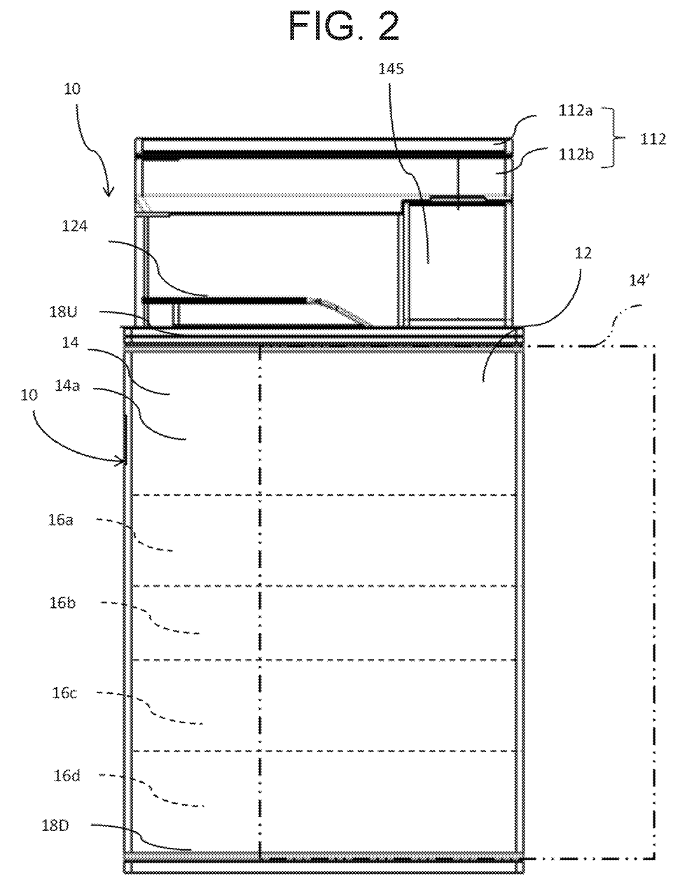

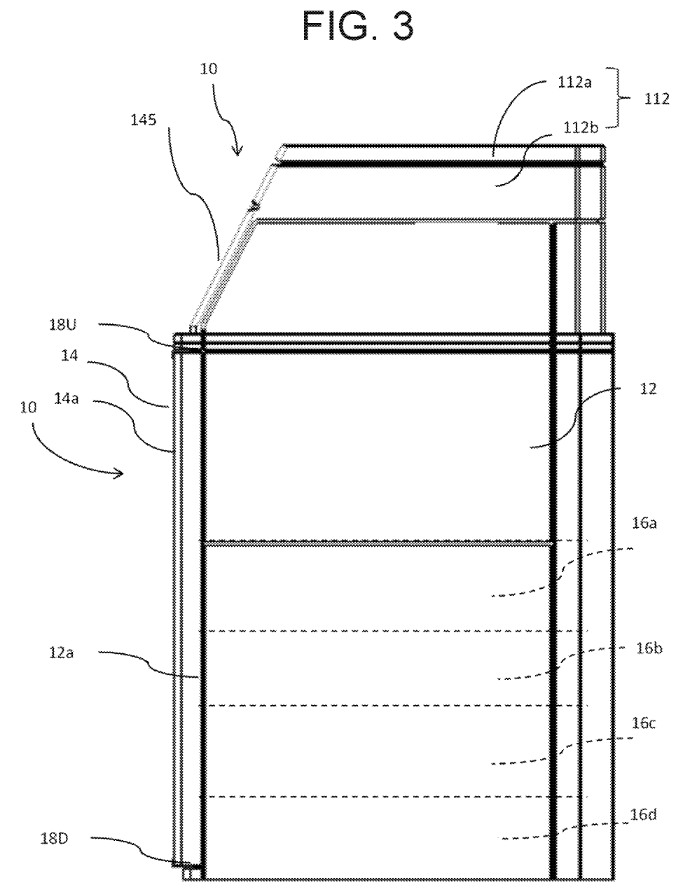

First, a configuration of an image forming apparatus 10 according to a first embodiment will be described. FIG. 1 is an explanatory perspective view of the image forming apparatus 10, FIG. 2 is a front view of the image forming apparatus 10, and FIG. 3 is a side view of the image forming apparatus 10.

As illustrated in FIGS. 1 - 3, an image forming apparatus 10 according to the first embodiment is an information processing apparatus that includes a document reader 112 on an upper portion of a main body 12, reads an image of a document, and outputs the image by an electrophotographic method, and is a multifunction printer having various functions such as a copy machine function, a printer function, and a facsimile function.

The main body 12 has a substantially rectangular parallelepiped shape slightly longer in the vertical direction than in the horizontal direction, the document reader 112 and the sheet discharge tray 124 are provided on the upper portion of the main body 12, and an operation panel 145 composed of a substantially plate-shaped touch panel in which an operation acceptor 140 and a display 150 are integrated is provided on a front side of the document reader 112 and the sheet discharge tray 124 with a display surface facing obliquely upward.

The document reader 112 is provided with a document placement 112b on which a document placement surface having a contact glass (not shown) is provided, and an openable and closable document cover 112a that covers the document placement 112b from above. An automatic document feeder (auto feeder) may be used for the document reader 112.

### 1.2 Flat Panel 14

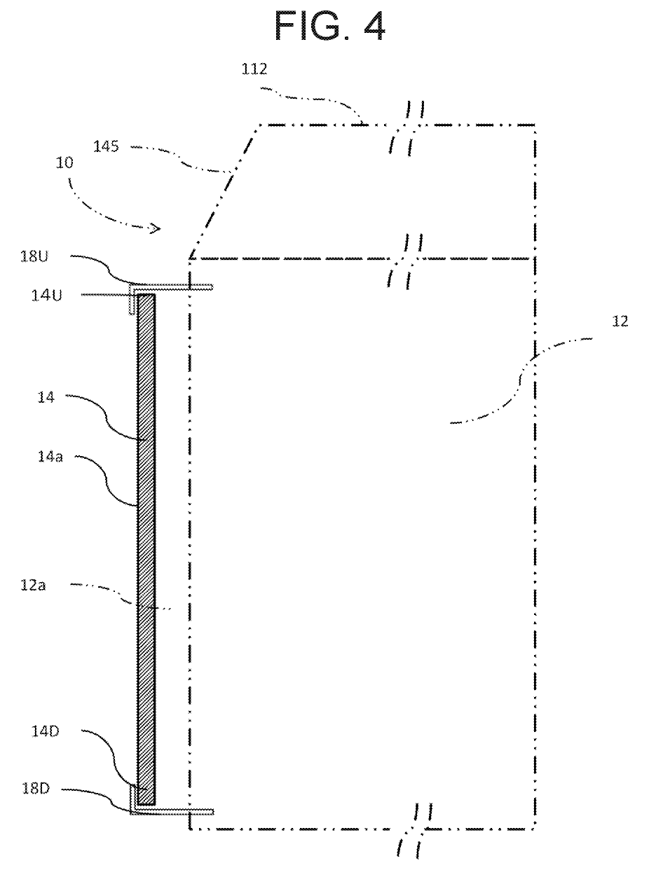

FIG. 4 is an explanatory view of a mounting structure of the flat panel 14.

As illustrated in FIGS. 1 - 4, in the first embodiment, the flat panel 14 is provided as a cover member that covers a front outer surface 12a (an example of an outer surface) of the main body 12 of the image forming apparatus 10 from the outside, and the surface of the flat panel 14 that is opposite to the main body 12 serves as a display surface 14a on which an image is displayed.

The flat panel 14 is detachably mounted on the front outer surface 12a of the main body 12. Specifically, an upper rail 18U is provided at an upper portion of the front outer surface 12a of the main body 12, and a lower rail 18D is provided at a lower portion of the front outer surface 12a of the main body 12. The upper rail 18U and the lower rail 18D hold an upper end 14U and a lower end 14D of the flat panel 14, respectively, between the upper rail 18U and the lower rail 18D, and thereby, the flat panel 14 is supported so as to be slidable in the left-right direction.

As shown in detail in FIG. 4, each of the upper rail 18U and the lower rail 18D is an elongated member (for example, having a rail shape) having a substantially L-shaped cross section perpendicular to the longitudinal direction, and the distal ends of the upper rail 18U and the lower rail 18D extend to each other. An upper end 14U and a lower end 14D of the flat panel 14 are each held between an inner side of the L-shaped portion and the front outer surface 12a of the main body, and therefore, the flat panel is slidable (slidably supported) in the left-right direction. In FIG. 2, a state in which the flat panel 14 is being slid to be detached or attached is indicated by a two dot chain line 14'.

The cross sectional shape of the rail is not limited to an L-shape. Any shape may be used as long as the flat panel 14 can be slidably held. For example, a groove shape having a U-shaped, C-shaped, or circular cross section may be used, or a fitting structure may be used. Furthermore, in the present embodiment, the rails (recesses) are provided on the main body 12, but the present invention is not limited to this. Rails or grooves may be provided on the flat panel 14, and protrusions or guide members that engage with the rails or grooves may be provided on the main body 12.

As shown in FIG. 2, a sheet feeding cassette for accommodating recording sheets on which a toner image is formed in the image former is disposed on the front side in the front portion of the main body 12. A plurality of sheet feeding cassettes are provided for each size of the recording sheets (in the embodiment, there are four sheet feeding cassettes, and the respective sheet feeding cassettes are indicated by broken lines 16a to 16d in FIG. 1). In a state in which the flat panel 14 is removed laterally, recording sheets can be supplied to the sheet feeding cassettes 16a to 16d from the front surface side of the main body 12.

Here, the "front surface (front outer surface)" of the main body 12 refers to a surface on a side that a user faces when the image forming apparatus 10 is normally used. It should be noted that the "front surface" in the present disclosure is not limited to a strict planar portion facing the front direction, and is a concept including a corner curved toward the side surface and a region reaching a part of the side surface.

In addition, it is preferable that the main body 12 is provided with a lock mechanism that restricts and locks the movement (for example, sliding or removal) of the flat panel 14. In addition, when the flat panel 14 is mounted, the flat panel 14 is disposed at a position where the flat panel 14 physically blocks the pull-out direction (front side) of each of the sheet feeding cassettes 16a to 16d. Therefore, only by locking the flat panel 14, opening and closing of all of the sheet feeding cassettes 16a to 16d behind the flat panel 14 can be restricted. Therefore, it is not necessary to provide an individual lock mechanism for each of the sheet feeding cassettes 16a to 16d. Further, the flat panel 14 prevents users from easily operating each of the sheet feeding cassettes 16a to 16d, thereby preventing the sheets from being robbed (improving security).

Here, as the configuration of the lock mechanism, both of a mechanical type and an electric type can be adopted. For example, the mechanical type lock mechanism can have a configuration in which, for example, a cylinder lock or a dial lock is provided so as to extend over the flat panel 14 and the main body 12 (or the upper rail 18U and the lower rail 18D), or a hole for attaching a padlock is provided.

In addition, the electric type lock mechanism can have a configuration in which an electronic lock using an electromagnetic actuator is provided on the main body 12 side and a lock pin is moved forward and backward with respect to an engagement portion of the flat panel 14. In this case, the controller 100 may perform control to release the electronic lock only when an authentication operation is received from the operation acceptor 140 or the like.

The flat panel 14 has a flat design on the front surface, and can display an image by attaching a sheet on which an image is displayed to a flat display surface 14a.

The sheet on which an image is displayed can be attached by film wrapping.

In addition, the flat panel has one single surface and separation of the flat panel for making doors is reduced. With respect to a conventional configuration, the steps and other irregularities of the boundary of a handle and a sheet feeding cassette can be reduced, and thereby, the front panel has one continuous surface. Accordingly, the front panel can be replaced without requiring cutting of the front panel.

Various lapping methods can be selected in accordance with the use and period.

As the upper rail 18 U and the lower rail 18D, slide rails are adopted that are arranged at positions conforming to the upper and lower portions of the front surface of the image forming apparatus in terms of design so as not to be conspicuous when a wrapping is not provided on the flat panel 14.

### 1.3 Control System of Image Forming Apparatus

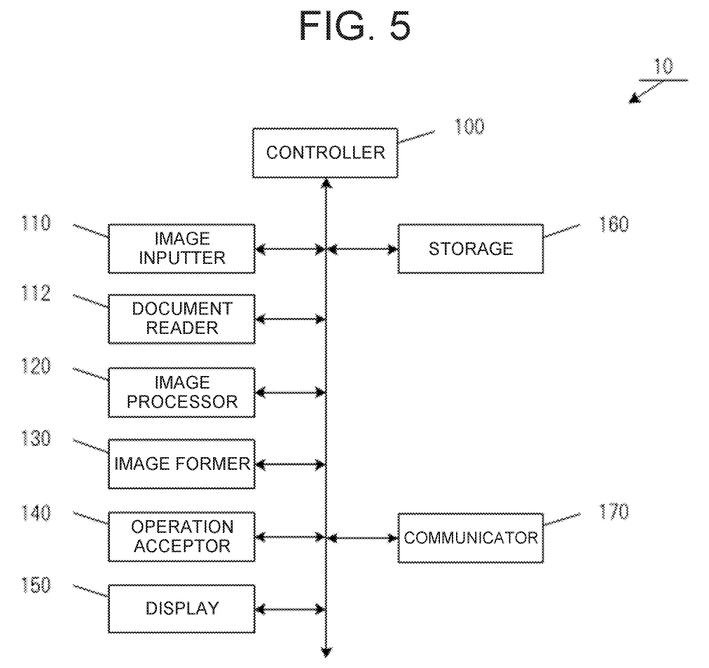

FIG. 5 is a block diagram of control of the image forming apparatus according to the first embodiment.

As illustrated in FIG. 5, the control system of the image forming apparatus 10 mainly includes, the controller 100, an image inputter 110, the document reader 112, an image processor 120, an image former 130, the operation acceptor 140, the display 150, a storage 160, and a communicator 170.

The controller 100 is a functional portion that performs overall control of the image forming apparatus 10.

Further, the controller 100 realizes various functions by reading and executing various programs, and is configured by, for example, one or more arithmetic devices (such as a central processing unit (CPU)) or the like.

The image inputter 110 is a functional portion for inputting image data that is input to the image forming apparatus 10. Further, the image inputter 110 is connected to the document reader 112 that is a functional portion for reading an image of a document, and receives the image data that is output from the document reader 112.

Moreover, the image inputter 110 may receive image data from a storage medium such as a USB memory or an SD card. Also, the image inputter 110 may receive image data from an other terminal device via the communicator 170 that connects to other terminal devices.

The document reader 112 has a function of optically reading a document placed on a contact glass (not shown), and passing the read data to the image processor 120.

The image former 130 is a functional portion for forming output data based on the image data on a recording medium (such as recording sheet). For example, as illustrated in FIG. 2, the recording sheet having a desired size is fed from any of the sheet feeding cassettes 16a to 16d, and after an image is formed on the surface of the recording sheet in the image former 130, the recording sheet is ejected to a sheet discharge tray 124. The image former 130 includes, for example, an electrophotographic laser printer.

The image processor 120 has an image processing function for converting the image data read in the document reader 112 into a set file format (such as TIFF, GIF, or JPEG). Then, an output image is formed based on the image data subjected to the image processing.

The operation acceptor 140 is a functional portion for accepting an operation instruction from a user, and is configured by various key switches, devices that detect input by contact, and the like. The user inputs the functions and output conditions to be used via the operation acceptor 140.

The display 150 is a functional portion for displaying various types of information to the user, and is configured, for example, by a liquid crystal display (LCD).

That is, the operation acceptor 140 provides a user interface for operating the image forming apparatus 10. The display 150 displays various setting menu screens of the image forming apparatus and messages.

The image forming apparatus 10 may include, as the configuration of the operation acceptor 140, a touch panel in which the operation panel 145 and the display 150 are integrally formed. In this case, the method of detecting inputs on the touch panel may be a general detection method, such as a resistive film method, an infrared method, an electromagnetic induction method, or an electrostatic capacitive method.

The storage 160 is a functional portion that stores various programs including a control program necessary for the operation of the image forming apparatus 10, various data including the read data, and user information. The storage 160 includes, for example, a non-volatile ROM (Read Only Memory), a RAM (Random Access Memory), an HDD (Hard Disk Drive), and the like. Furthermore, the storage 160 may include an SSD (Solid State Drive), which is a semiconductor memory.

The communicator 170 communicatively connects with an external device. A communication interface (communication I/F) used for sending and receiving data is provided as the communicator 170. With the communication I/F, a user operation made with respect to the image forming apparatus 10 allows the data stored in the storage of the image forming apparatus 10 to be sent to and received from an other computer device connected via a network.

### 1.4 Operations and Effects of Embodiment

According to the first embodiment, since the flat panel 14 may be attached to the image forming apparatus after the advertisement medium such as a sheet is wrapped on the flat panel 14, it is not necessary to perform the wrapping operation at night and there is no time restriction.

Further, although the front outer surface 12a of the image forming apparatus has irregularities such as the boundary of the sheet feeding cassette, the handle, and the like, the flat panel 14 is mounted between the upper rail 18U and the lower rail 18D, and thereby, the flat panel 14 is not directly mounted on the front outer surface and is spaced apart from the front outer surface. Therefore, the flat panel 14 can be mounted without interfering with the irregularities. Therefore, there is no work restriction that a special work is conducted by a worker having special skills in which a dryer is used so that the advertisement medium that has been attached to the front surface follows the irregularities and a cutter is used to cut the advertisement medium so that the sheet feeding cassette can be opened.

Further, there is no image restriction that the layout of the sheet feeding cassette needs to be considered for the wrapping image. Therefore, the wrapping can be performed not only in the limited store, and the range of image selection is widened.

As described above, according to the image forming apparatus of the first embodiment, since the detachable flat panel 14 is adopted to display an image, the range of image selection is widened, and even a worker who does not have a special skill can conduct work of the flat panel 14 (not a professional but an employee of a store or the like can conduct work of the flat panel 14). Therefore, anyone can easily conduct wrapping work without image restriction. As a result, there is an excellent effect that the wrapping work can be conducted not only in a limited store such as a permanent collaboration store but also in a local spot store, and that the effective wrapping work can be provided at an appropriate timing according to a scene such as a limited-period campaign.

### 1.5 Modification Example 1

As a modification example 1 of the first embodiment, the upper rail 18U and the lower rail 18D shown in FIGS. 1 - 3 are omitted, and a magnetic body (not shown) is provided on at least one of the front outer surface 12a of the main body 12 of the image forming apparatus 10 and the rear surface of the flat panel 14, so that the flat panel 14 is attached to the front outer surface 12a by the magnetic force of the magnetic body and can be detachably fixed to the front outer surface 12a.

According to the modification example 1, in addition to the operation and effect of the first embodiment, it is not necessary to provide the upper rail 18U and the lower rail 18D, and the flat panel 14 can be provided only by providing a magnet on one of the front outer surface 12a of the main body of the image forming apparatus 10 and the rear surface of the flat panel 14, and providing a magnetic material on the other of the front outer surface 12a of the main body of the image forming apparatus 10 and the rear surface of the flat panel 14. Thus, the configuration is simplified and the installation is easily conducted.

When the front outer surface of the main body or the rear surface of the flat panel is made of a magnetic material, it is necessary to provide a magnet only on one of the main body 12 and the flat panel 14, and it is not necessary to provide a magnetic material on the other of the main body 12 and the flat panel 14. Thus, the installation configuration can be further simplified.

It is preferable to dispose a magnet sheet as the magnet so that the magnet does not affect printing by the printer.

### 1.6 Modification Example 2

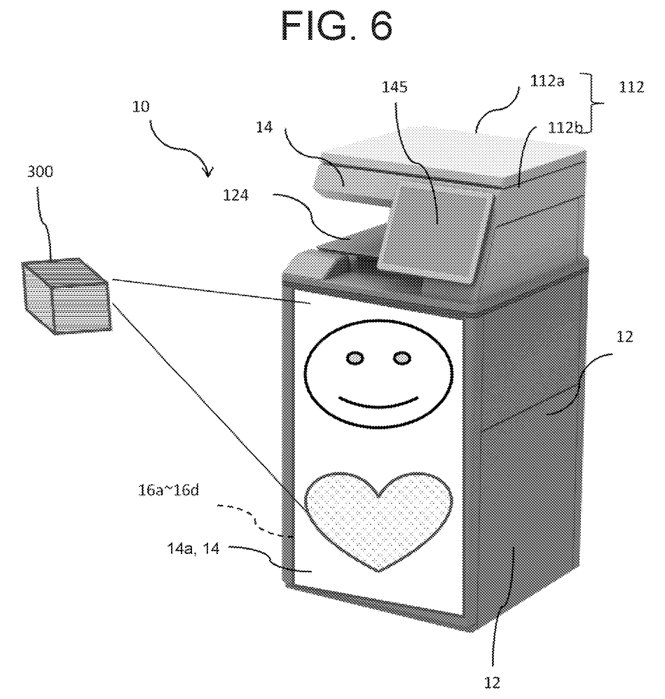

FIG. 6 is an explanatory diagram of a modification example 2.

As the modification example 2 of the first embodiment, the flat panel 14 can display an image on a surface of the flat panel 14 by a separate projector that projects an image onto the flat display surface 14a. For example, the display surface 14a is used as a screen for displaying a moving image or a still image. The display surface 14a is preferably made of a mat-based fabric that is embossed to uniformly diffuse an image in all directions.

As shown in FIG. 6, an image can be displayed on the display surface 14a of the flat panel 14 by a projection device 300 such as a projector.

According to the modification example 2, in addition to the operation and effect of the first embodiment, there is an advantage that the image can be changed very easily since the image can be displayed on the display surface of the flat panel 14 by the projection of the image without performing processing such as lapping on the display surface 14a. In addition, it is possible to consider a configuration in which a moving image can also be projected as the projection image.

In addition, the projection device 300 may be communicably connected to the controller 100 of the image forming apparatus 10, and may be configured to switch the display content according to the operation state (status) of the image forming apparatus 10. For example, the controller 100 displays "signage content" such as an advertisement image or a store guide on the display surface 14a in a standby state (including a sleep mode or the like) in which image formation is not performed. On the other hand, during execution of printing by the image former 130 or during execution of scanning by the document reader 112, the controller 100 may cause the display surface 14a to display a progressing status of the job (for example, a remaining time, the number of sheets to be printed, or the like) or a message indicating "printing in progress".

Further, when an error such as out-of-paper (jamming), out-of-toner, or device abnormality occurs, the controller 100 may largely display a warning screen for notifying the occurrence of the error or a coping method (a movie of a procedure for coping with jamming, an enlarged view of a portion to be operated, or the like) on the display surface 14a. As compared with the normal operation panel 145, by utilizing the display surface 14a of the large screen covering the front surface of the main body 12, it is possible to clearly transmit the state of the image forming apparatus 10 to a user at a distant position, and to display the operation method in an easily understandable manner.

### 1.7 Other Modification Example

In the present embodiment and the modification example, the flat panel 14 having rigidity or the curtain-like member (roll screen) is exemplified as the cover member, but the present disclosure is not limited thereto. The cover member may be any member as long as it can cover a part or all of the outer surface of the image forming apparatus 10, and may be, for example, paper, cloth, nonwoven fabric, a resin sheet, or a sheet-like member (flexible member) having flexibility in which these are laminated. Such a flexible sheet material can be easily attached to follow the outer surface shape of the main body 12 even when the outer surface shape of the main body 12 is a curved surface.

In addition, the attachment structure and the opening and closing method of the cover member are not limited to the above-described "sliding method" and "winding method" using a rail. For example, the side end of the cover member may be supported on the main body 12 by a rotation shaft such as a hinge, and a "single swing (door type)" or "double swing" configuration that opens and closes like a door may be employed. In addition, a so-called "curtain type" configuration may be adopted in which only the upper end of the cover member is fixed to the main body 12 and the lower portion is suspended as a free end.

Further, as specific means (fixing means) for detachably or openably fixing the cover member to the main body 12, various means other than the rail and the magnet described above can be adopted. For example, the cover member may be directly or indirectly fixed to the front outer surface 12a of the main body 12 by using a hook-and-loop fastener (magic tape or the like), a snap button, hook engagement, a sucker, a removable adhesive material (adhesive sheet), or the like.

### 2 Image Forming Apparatus of Second Embodiment

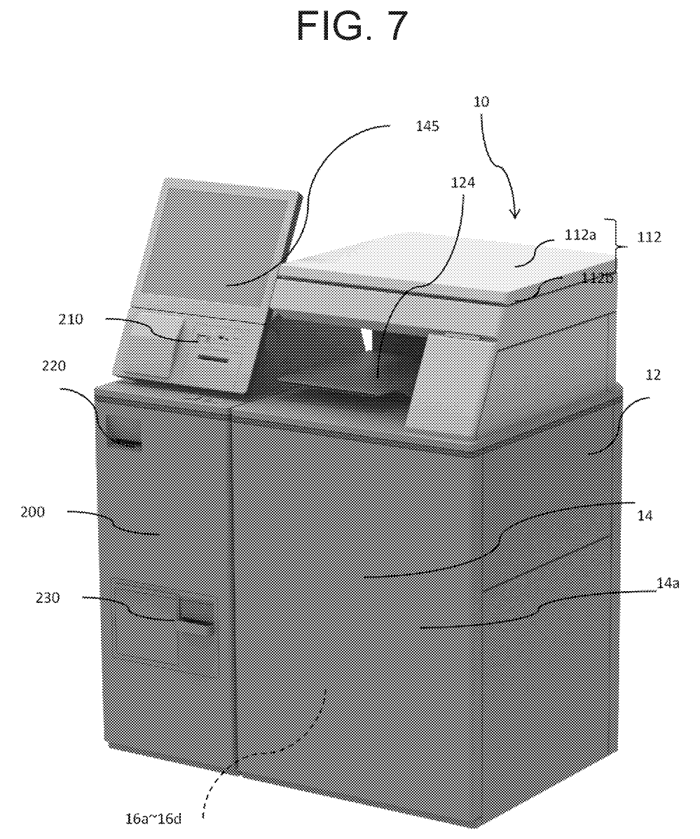

FIG. 7 is an explanatory perspective view of an image forming apparatus according to a second embodiment.

While the image forming apparatus according to the first embodiment shown in FIG. 1 is a narrow model without an application box, the image forming apparatus according to the second embodiment shown in FIG. 7 is a wide model with an application box 200.

In the image forming apparatus 10, the main body 12, the flat panel 14, and the like, the same parts as those in the first embodiment are denoted by the same reference numerals.

The application box 200 is provided with an operation panel 145 of an operation acceptor and a display, an SD, microSD, USB (Type-A, Type-C) installation slot 210, a bill insertion slot 220, and a coin payout slot 230. The operation panel 145 or the like is an example and can be installed as appropriate.

It should be noted that the application box 200 is a functional portion for using a copy, a printout, a facsimile, or the like by paying a usage fee with cash or an IC card, and is used in a store such as a convenience store on the assumption that an unspecified number of people use a copy machine. The image forming apparatus according to the first embodiment can be used in a store by providing a small application box (not shown).

In the second embodiment, in addition to the operation and effect of the first embodiment, an image can be displayed in a portion other than the holes such as the bill insertion slot 220 and the coin payout slot 230 of the application box 200, and the display area can be increased.

### 3 Image Forming Apparatus of Third Embodiment

In the image forming apparatus of the third embodiment, the cover member is not a flat panel but a windable curtain-like member. The cover member may cover a front outer surface 12a of the main body of the image forming apparatus in the extended state, and the outer surface of the main body may be exposed in a state in which the cover member is wound up. An example of a winding position of the cover member made of the curtain-like member is shown by a curtain-like member 400 in FIG. 1.

In this case, the cover member is a pull-cord type roll screen member that is extended downward from the upper portion of the front outer surface 12a. The front outer surface 12a is exposed in a state in which the cover member is wound in an upper portion.

A roll curtain that is automatically rolled up when the cord is pulled downward or a seat belt that is automatically rolled up can be imagined.

When the pull-cord type roll screen member is used as the cover member, the roll screen member is simply wound upward when stored, and therefore, the roll screen member is not so conspicuous as it is.

According to the third embodiment, there is an excellent effect that the cover member is easy to handle and is highly convenient, and the cover member does not become an obstacle at the time of maintenance of the sheet feeding cassette when the cover member is wound up.

Although an embodiment has been described above, specific configurations are not limited to the embodiment, and designs and the like that do not deviate from the gist of the present disclosure are also included in the scope of the claims.

In addition, in the embodiment, the program that operates in each device in the embodiment is a program that controls a CPU or the like (a program that causes a computer to function) such that the functions of the embodiment described above are realized. Further, the information handled by the devices is temporarily stored in a temporary storage device (such as a RAM) during processing, and then stored in various storage devices, such as a ROM or an HDD, and is read, corrected, and written by the CPU as necessary.

Here, a recording medium for storing the program may be any non-transitory recording medium, such as a semiconductor medium (for example, a ROM or a nonvolatile memory card), an optical recording medium or a magneto-optical recording medium (for example, a digital versatile disc (DVD), a magneto optical disc (MO), a mini disc (MD), a compact disc (CD), or a Blu-ray (registered trademark) disc), or a magnetic recording medium (for example, a magnetic tape or a flexible disk).

Furthermore, the functions of the embodiment described above are realized not only by executing a loaded program. The functions of the present disclosure can also be realized by processing in cooperation with an operating system, other application programs, or the like, based on the instructions of the program.

In addition, when a program is distributed to the market, the program can be stored in a portable storage device before distribution, or transferred to a server computer connected via a network such as the Internet. In this case, a storage device of the server computer is obviously also included in the present disclosure.

In addition, some or all of the devices in the embodiment described above may be realized as a Large Scale Integration (LSI), which is typically an integrated circuit. The functional blocks of the devices may be individually formed as a chip, or may be partially or wholly integrated and formed as a chip. Furthermore, the technique of achieving an integrated circuit is not limited to an LSI, and may be realized by a dedicated circuit or by a general-purpose processor. Moreover, when a technology that achieves an integrated circuit that replaces LSI emerges due to advances in semiconductor technology, it will of course be possible to use an integrated circuit based on such a technology.

What is claimed is:

1. An image forming apparatus comprising a cover member that covers a main body of an image forming apparatus from an outside, wherein a surface of the cover member is a display surface that displays an image.

2. The image forming apparatus according to claim 1, wherein the cover member is a flat panel detachably provided on a front outer surface of the main body of the image forming apparatus.

3. The image forming apparatus according to claim 2, wherein an upper rail and a lower rail are provided on the front outer surface of the main body of the image forming apparatus, and the upper rail and the lower rail support the flat panel between the upper rail and the lower rail so that the flat panel is slidable to left and right.

4. The image forming apparatus according to claim 2, wherein a magnetic body is provided on at least one of the front outer surface of the main body of the image forming apparatus and a rear surface of the flat panel, and the flat panel is attached to the front outer surface of the main body by a magnetic force of the magnetic body so as to be detachably fixed thereto.

5. The image forming apparatus according to claim 2, wherein a sheet having a surface on which an image is displayed is attached to the flat panel so that the flat panel can display an image.

6. The image forming apparatus according to claim 5, wherein a sheet on which the image is displayed is attached to the flat panel by film wrapping.

7. The image forming apparatus according to claim 1, wherein the cover member is a windable curtain-like member that covers an outer surface of the main body of the image forming apparatus when the cover member is in an extended state and exposes the outer surface of the main body when the cover member is in a wound state.

8. The image forming apparatus according to claim 7, wherein the cover member is a pull-cord type roll screen member and is extended downward from an upper portion of the outer surface of the main body, and an outer surface of the main body is exposed in a state in which the cover member is wound in the upper portion.

9. The image forming apparatus according to claim 1, wherein the cover member can display an image by a projector that is separate from the cover member and projects a projection image onto the surface of the cover member.
